(19) United States
(12) Patent Application Publication
(10) Pub. No.: US 2025/0096854 A1
(43) Pub. Date: Mar. 20, 2025

(54) RECONFIGURABLE INTELLIGENT SURFACE (RIS) INTERFERENCE MANAGEMENT

(71) Applicant: QUALCOMM Incorporated, San Diego, CA (US)

(72) Inventors: Narayan PRASAD, Westfield, NJ (US); Yu-Chin OU, San Diego, CA (US); Mahmoud TAHERZADEH BOROUJENI, San Diego, CA (US); Tao LUO, San Diego, CA (US); Mohammad Ali TASSOUDJI, San Diego, CA (US); Junyi LI, Fairless Hills, PA (US)

(21) Appl. No.: 18/467,219

(22) Filed: Sep. 14, 2023

(51) Int. Cl. H04B 7/04; H04B 7/0456

(52) U.S. Cl. CPC H04B 7/04026; H04B 7/0456

(57) ABSTRACT

Various aspects of the present disclosure generally relate to wireless communication. In some aspects, a network node may transmit, to a reconfigurable intelligent surface (RIS), information identifying a RIS configuration, wherein the RIS configuration includes one or more parameters for a time-varying control configuration associated with side-lobe suppression. The network node may communicate, via the RIS and using the RIS configuration, with a user equipment (UE). Numerous other aspects are described.

### FIELD OF THE DISCLOSURE

Aspects of the present disclosure generally relate to wireless communication and to techniques and apparatuses for reconfigurable intelligent surface interference management.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a network node. The method may include transmitting, to a reconfigurable intelligent surface (RIS), information identifying a RIS configuration, wherein the RIS configuration includes one or more parameters for a time-varying control configuration associated with side-lobe suppression. The method may include communicating, via the RIS and using the RIS configuration, with a user equipment (UE).

Some aspects described herein relate to a method of wireless communication performed by a RIS. The method may include receiving, from a network node, information identifying a RIS configuration, wherein the RIS configuration includes one or more parameters for a time-varying control configuration associated with side-lobe suppression. The method may include forwarding, using the RIS configuration, one or more communications between the network node and a UE.

Some aspects described herein relate to a method of wireless communication performed by a UE. The method may include receiving, from a network node and via a RIS, information identifying one or more power control configuration parameters for communication with the network node via the RIS, wherein the power control configuration parameters relate to a RIS configuration that includes one or more parameters for a time-varying control configuration associated with side-lobe suppression. The method may include communicating, via the RIS and using the one or more power control configuration parameters, with the network node.

Some aspects described herein relate to a non-transitory computer-readable medium that stores a set of instructions for wireless communication by a network node. The set of instructions, when executed by one or more processors of the network node, may cause the network node to transmit, to a RIS, information identifying a RIS configuration, wherein the RIS configuration includes one or more parameters for a time-varying control configuration associated with side-lobe suppression. The set of instructions, when executed by one or more processors of the network node, may cause the network node to communicate, via the RIS and using the RIS configuration, with a UE.

Some aspects described herein relate to a non-transitory computer-readable medium that stores a set of instructions for wireless communication by a RIS. The set of instructions, when executed by one or more processors of the RIS, may cause the RIS to receive, from a network node, information identifying a RIS configuration, wherein the RIS configuration includes one or more parameters for a time-varying control configuration associated with side-lobe suppression. The set of instructions, when executed by one or more processors of the RIS, may cause the RIS to forward, using the RIS configuration, one or more communications between the network node and a UE.

Some aspects described herein relate to a non-transitory computer-readable medium that stores a set of instructions for wireless communication by a UE. The set of instructions, when executed by one or more processors of the UE, may cause the UE to receive, from a network node and via a RIS, information identifying one or more power control configuration parameters for communication with the network node via the RIS, wherein the power control configuration parameters relate to a RIS configuration that includes one or more parameters for a time-varying control configuration associated with side-lobe suppression. The set of instructions, when executed by one or more processors of the UE, may cause the UE to communicate, via the RIS and using the one or more power control configuration parameters, with the network node.

Some aspects described herein relate to a network node for wireless communication. The network node may include one or more memories and one or more processors coupled to the one or more memories. The one or more processors may be configured to transmit, to a RIS, information identifying a RIS configuration, wherein the RIS configuration includes one or more parameters for a time-varying control configuration associated with side-lobe suppression. The one or more processors may be configured to communicate, via the RIS and using the RIS configuration, with a UE.

Some aspects described herein relate to a RIS for wireless communication. The reconfigurable intelligent surface may include one or more memories and one or more processors coupled to the one or more memories. The one or more processors may be configured to receive, from a network node, information identifying a RIS configuration, wherein the RIS configuration includes one or more parameters for a time-varying control configuration associated with side-lobe suppression. The one or more processors may be configured to forward, using the RIS configuration, one or more communications between the network node and a UE.

Some aspects described herein relate to a UE for wireless communication. The user equipment may include one or more memories and one or more processors coupled to the one or more memories. The one or more processors may be configured to receive, from a network node and via a RIS, information identifying one or more power control configuration parameters for communication with the network node via the RIS, wherein the power control configuration parameters relate to a RIS configuration that includes one or more parameters for a time-varying control configuration associated with side-lobe suppression. The one or more processors may be configured to communicate, via the RIS and using the one or more power control configuration parameters, with the network node.

Some aspects described herein relate to an apparatus for wireless communication. The apparatus may include means for transmitting, to a RIS, information identifying a RIS configuration, wherein the RIS configuration includes one or more parameters for a time-varying control configuration associated with side-lobe suppression. The apparatus may include means for communicating, via the RIS and using the RIS configuration, with a UE.

Some aspects described herein relate to an apparatus for wireless communication. The apparatus may include means for receiving, from a network node, information identifying a RIS configuration, wherein the RIS configuration includes one or more parameters for a time-varying control configuration associated with side-lobe suppression. The apparatus may include means for forwarding, using the RIS configuration, one or more communications between the network node and a UE.

Some aspects described herein relate to an apparatus for wireless communication. The apparatus may include means for receiving, from a network node and via a RIS, information identifying one or more power control configuration parameters for communication with the network node via the RIS, wherein the power control configuration parameters relate to a RIS configuration that includes one or more parameters for a time-varying control configuration associated with side-lobe suppression. The apparatus may include means for communicating, via the RIS and using the one or more power control configuration parameters, with the network node.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a repeater, in accordance with the present disclosure.

FIG. 5 is a diagram illustrating an example of communicating using a repeater, in accordance with the present disclosure.

FIG. 6 is a diagram illustrating an example of beam patterns for communication using a repeater, in accordance with the present disclosure.

FIG. 7 is a diagram illustrating an example associated with repeater interference management, in accordance with the present disclosure.

FIG. 8 is a diagram illustrating an example associated with repeater interference management, in accordance with the present disclosure.

FIG. 9 is a diagram illustrating an example process performed, for example, at a network node or an apparatus of a network node, in accordance with the present disclosure.

FIG. 10 is a diagram illustrating an example process performed, for example, at a reconfigurable intelligent surface (RIS) or an apparatus of a RIS, in accordance with the present disclosure.

FIG. 11 is a diagram illustrating an example process performed, for example, at a UE or an apparatus of a UE, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

In some communications systems, a repeater may be used to enable communications between different devices. For example, when an obstruction is present between a network node and a user equipment (UE), the network node and UE may be unable to communicate directly; accordingly, a repeater may be deployed to enable the network node and the UE to communicate. In this case, the network node may transmit a communication toward the repeater, which may forward, re-direct, re-transmit, or otherwise repeat the communication toward the UE and vice versa. One example of a repeater that can be used for indirect communications is a reconfigurable intelligent surface (RIS), as described in more details herein. A RIS can be configured to reflect a target incident signal with enhanced gain along a configured reflect direction (or at a configured focusing point). This can boost a signal strength, thereby improving communications between devices. Furthermore, a reflect beam pattern, with high directivity as occurs with RIS-forwarded communications, can be used for sensing.

However, when a RIS reflects a beam in a configured direction with a main lobe of a beam, the RIS may also reflect interference in undesired direction with a set of sidelobes of the beam. The main lobe refers to a lobe (e.g., a global maximum) of a radio antenna's radiation pattern that contains a highest power (e.g., a lobe with a highest field strength in, for example, a far field). The sidelobes are lobes (e.g., local maxima) of the radio antenna's radiation pattern with lower powers in the far field. Introducing relatively high levels of interference in specific directions can adversely affect ongoing communications in the specific directions, reduce interference randomization (e.g., by creating burst-y interference, which can reduce an effectiveness of link adaptation procedures), or reduce an accuracy of sensing (e.g., by causing false detections and increasing scan latency in sensing procedures), among other examples.

Some techniques, as described in more detail herein, that are applicable on devices to obviate issues in directional interference include phase-only reflect beam synthesis and phased-array tapering. However, a RIS may have a relatively small reflection coefficient alphabet (e.g., limited to a 1-bit or 2-bit alphabet of phases that can assigned to each RIS antenna element), which limits phase-only reflect beam synthesis by quantization errors, thereby resulting in prominent a side-lobe level (SLL). Further, a RIS may lack independent amplitude control, which may prevent application of phased-array tapering techniques.

Some aspects described herein may enable SLL suppression in communication systems that use a RIS for repeated communication between other devices (e.g., a UE and a network node). For example, a network node may configure a RIS with a RIS configuration that includes one or more parameters for time-varying control associated with side-lobe suppression. In this case, the RIS may apply the RIS configuration when forwarding communications between the network node and a UE. For example, the RIS may apply an amplitude taper at an operation frequency using a relatively small reflection coefficient algorithm. Additionally, or alternatively, a RIS may spread reflected signal energy using dithering based at least in part on time offsets, thereby suppressing SLL. In some aspects, a network node may configure the RIS with parameterized codebooks that provide SLL suppression at different central frequencies. In some aspects, the network node and the RIS may communicate to set the RIS configuration with a taper or other SLL suppression technique configured. In some aspects, a network node may set a taper for the RIS. In some aspects, a UE may be configured to interpret a set of power control commands to mitigate issues relating to interference at a RIS. In this way, by transmitting information identifying a RIS configuration, as described in more detail herein, devices in a network can communicate with reduced interference resulting from sidelobes of a RIS beam. Additionally, or alternatively, by configuring a UE to interpret power control commands using a particular command interpretation, the network node can enable communication using a RIS that is configured with a RIS configuration.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

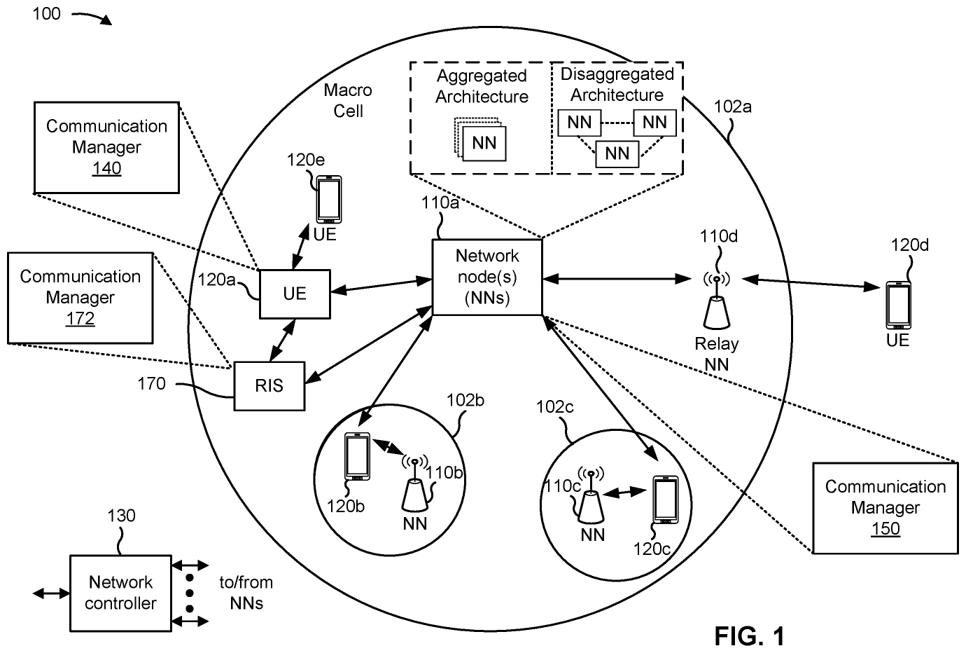

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

In some examples, a UE 120 (for example, shown as UE 120a) may communicate with a network node (for example, show as network node 110a) indirectly via a RIS 170. For example, a RIS 170 may receive a communication a network node 110 and forward, reflect, repeat, or otherwise retransmit the communication to the UE 120 or vice versa. Although some aspects are described herein in terms of a RIS, other types of repeaters, retransmitters, or reflectors are contemplated.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the network node 110 may include a communication manager 150. As described in more detail elsewhere herein, the communication manager 150 may transmit, to a RIS, information identifying a RIS configuration, wherein the RIS configuration includes one or more parameters for a time-varying control configuration associated with side-lobe suppression; and communicate, via the RIS and using the RIS configuration, with a UE. Additionally, or alternatively, the communication manager 150 may perform one or more other operations described herein.

In some aspects, the RIS 170 may include a communication manager 172. As described in more detail elsewhere herein, the communication manager 172 may receive, from a network node, information identifying a RIS configuration, wherein the RIS configuration includes one or more parameters for a time-varying control configuration associated with side-lobe suppression; and forward, using the RIS configuration, one or more communications between the network node and a UE. Additionally, or alternatively, the communication manager 172 may perform one or more other operations described herein.

In some aspects, the UE 120 may include a communication manager 140. As described in more detail elsewhere herein, the communication manager 140 may receive, from a network node and via a RIS, information identifying one or more power control configuration parameters for communication with the network node via the RIS, wherein the power control configuration parameters relate to a RIS configuration that includes one or more parameters for a time-varying control configuration associated with side-lobe suppression; and communicate, via the RIS and using the one or more power control configuration parameters, with the network node. Additionally, or alternatively, the communication manager 140 may perform one or more other operations described herein.

As indicated above, FIG. 1 is provided as an example. Other examples may differ from what is described with regard to FIG. 1.

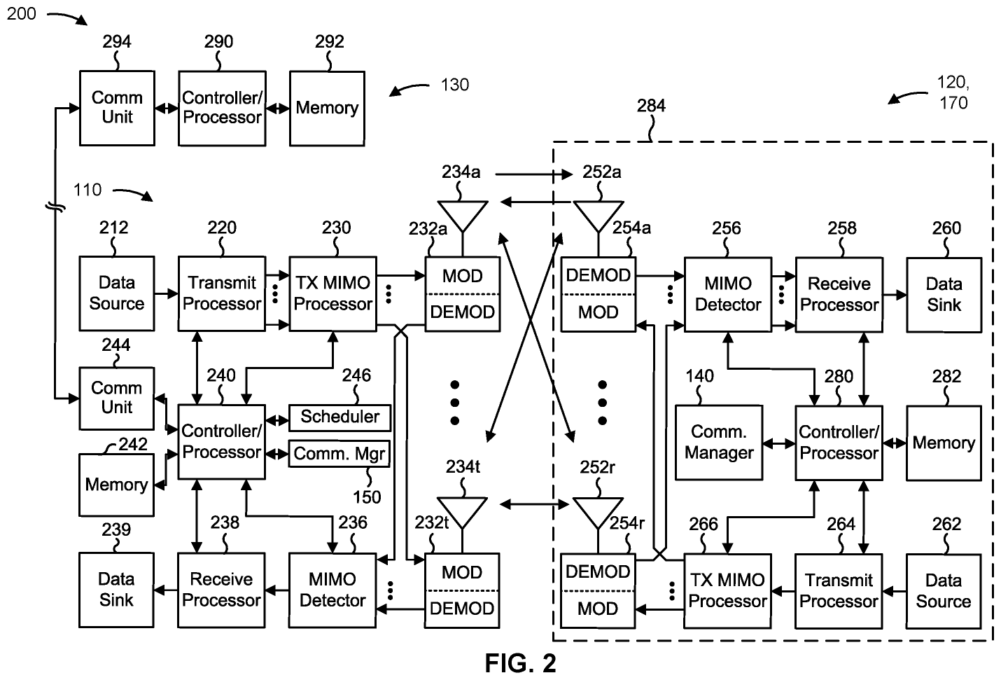

FIG. 2 is a diagram illustrating an example 200 of a network node 110 in communication with a UE 120 in a wireless network 100. In some examples, the network node 110 may be in communication with the UE 120 via a RIS 170. The network node 110 may be equipped with a set of antennas 234a through 234t, such as T antennas (T>1). The UE 120 (or the RIS 170) may be equipped with a set of antennas 252a through 252r, such as R antennas (R>1). Although some components are described herein in terms of being included in the UE 120, it is contemplated that some, all, additional, or different components described herein may be included in a RIS 170. The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120 (and/or at the RIS 170), a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

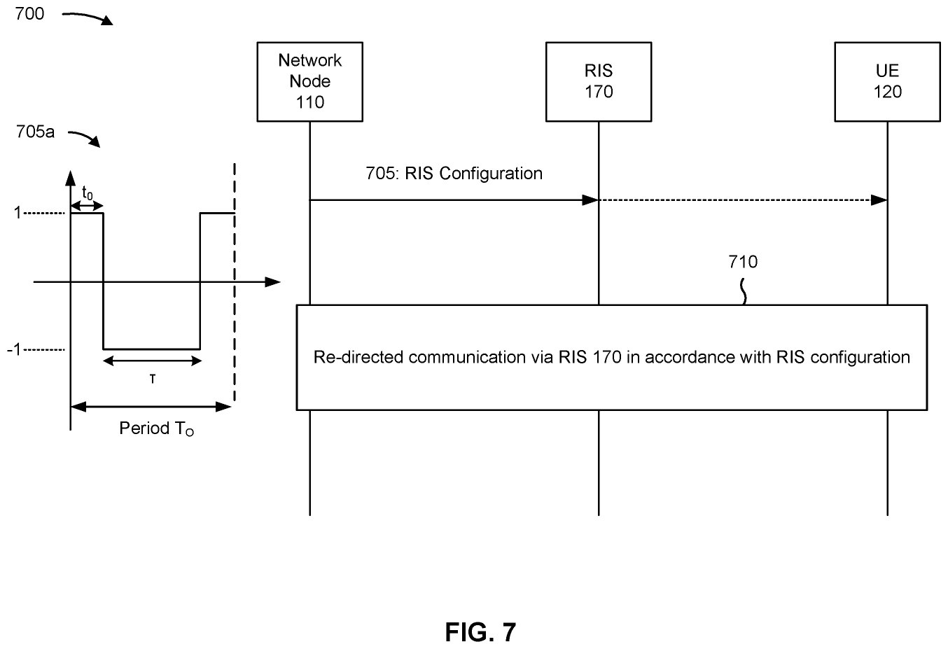

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 7-14).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 7-14).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

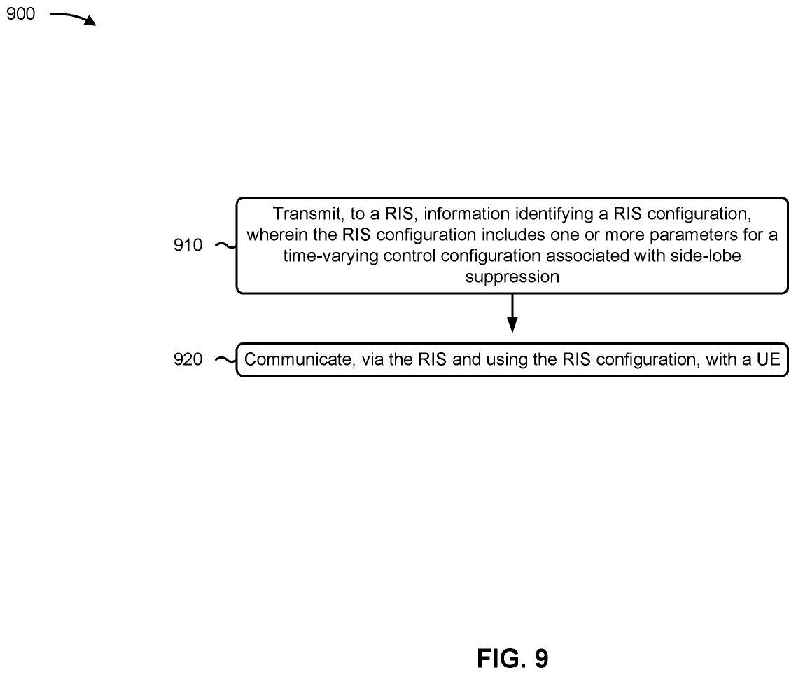

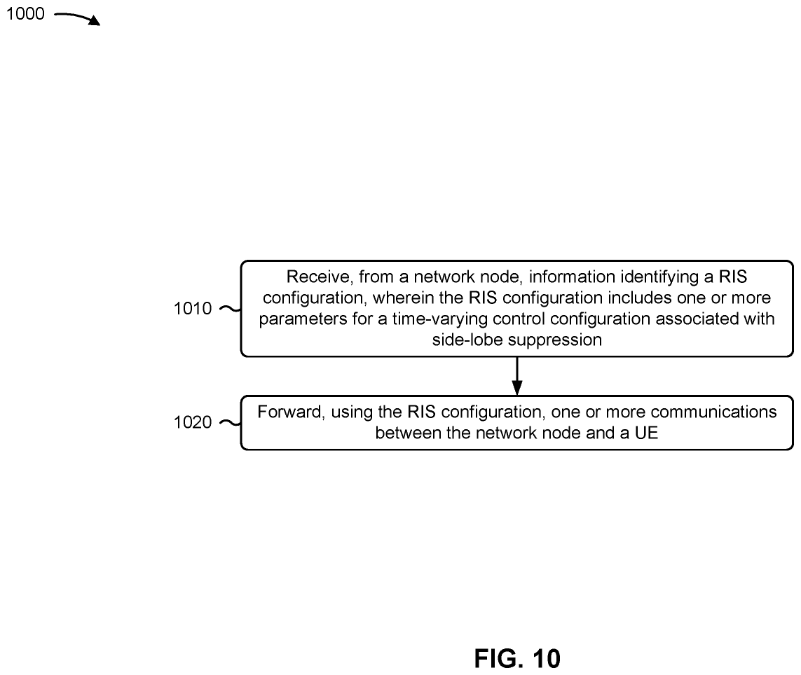

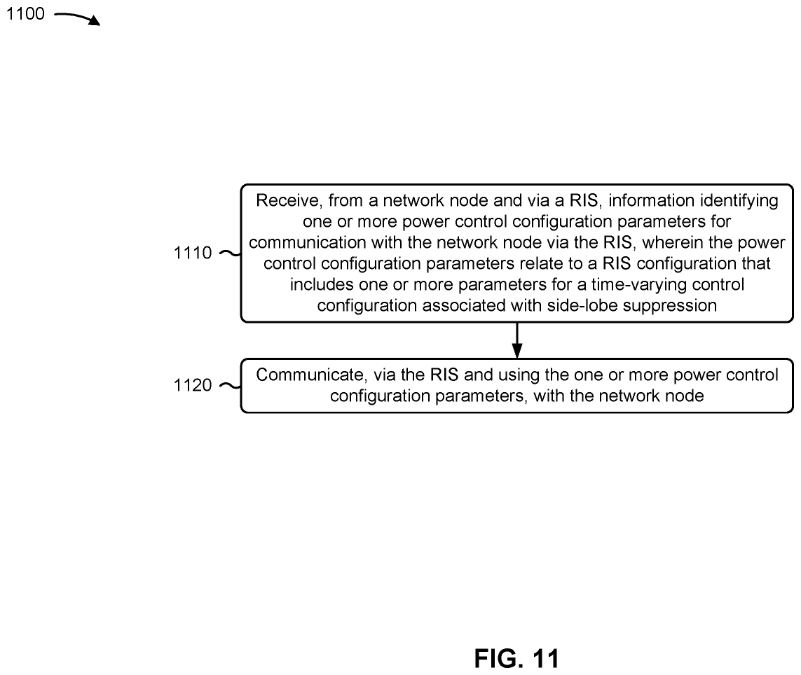

The controller/processor 240 of the network node 110, the controller/processor 280 of the UE 120, or any other component(s) of FIG. 2 may perform one or more techniques associated with repeater interference management, as described in more detail elsewhere herein. For example, the controller/processor 240 of the network node 110, the controller/processor 280 of the UE 120 or RIS 170, or any other component(s) (or combinations of components) of FIG. 2 may perform or direct operations of, for example, process 900 of FIG. 9, process 1000 of FIG. 10, process 1100 of FIG. 11, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the network node 110 includes means for transmitting, to a RIS, information identifying a RIS configuration, wherein the RIS configuration includes one or more parameters for a time-varying control configuration associated with side-lobe suppression; and/or means for communicating, via the RIS and using the RIS configuration, with a UE. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the RIS 170 includes means for receiving, from a network node, information identifying a RIS configuration, wherein the RIS configuration includes one or more parameters for a time-varying control configuration associated with side-lobe suppression; and/or means for forwarding, using the RIS configuration, one or more communications between the network node and a UE. In some aspects, the means for the RIS 170 to perform operations described herein may include, for example, one or more of communication manager 172, antenna 252, modem 254, MIMO detector 256, receive processor 258, transmit processor 264, TX MIMO processor 266, controller/processor 280, or memory 282.

In some aspects, the UE 120 includes means for receiving, from a network node and via a RIS 170, information identifying one or more power control configuration parameters for communication with the network node via the RIS, wherein the power control configuration parameters relate to a RIS configuration that includes one or more parameters for a time-varying control configuration associated with side-lobe suppression; and/or means for communicating, via the RIS and using the one or more power control configuration parameters, with the network node. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

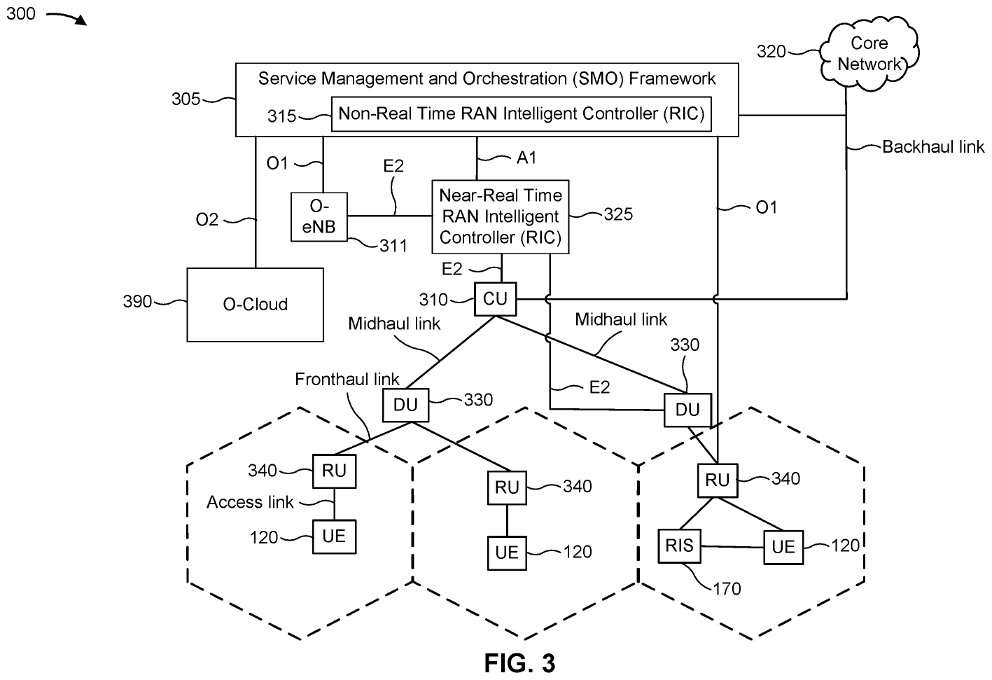

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some examples, a UE 120 may be simultaneously served by multiple RUs 340. In some examples, a UE 120 may communicate with an RU 340 via a RIS 170.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

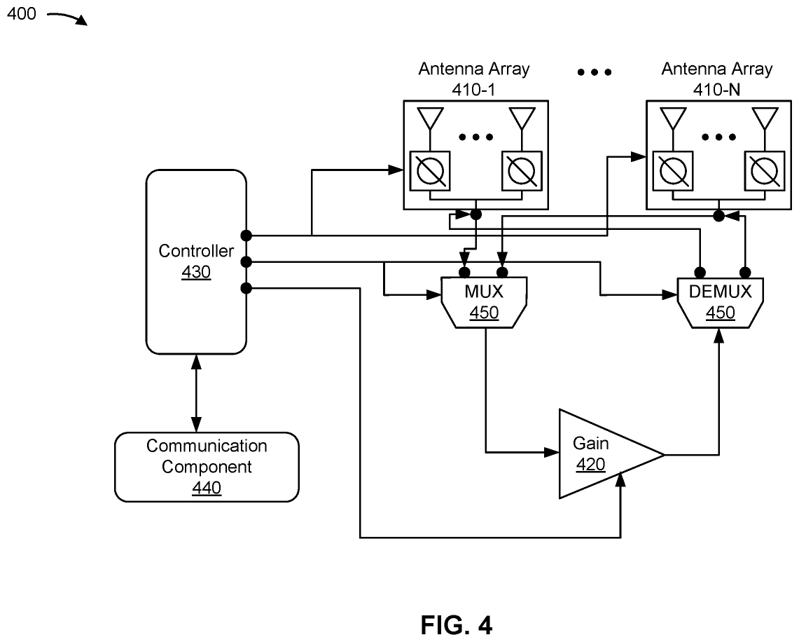

FIG. 4 is a diagram illustrating an example of a repeater 400, in accordance with the present disclosure. In some examples, repeat 400 may be a millimeter wave repeater. In some examples, repeater 400 may correspond to the RIS 170 shown in FIG. 1. As shown in FIG. 4, the repeater 400 may include one or more antenna arrays 410-1 through 410-N (N>1), a gain component 420, a controller 430, a communication component 440, and a multiplexer (MUX) and/or demultiplexer (DEMUX) (MUX/DEMUX) 450.

An antenna array 410 includes multiple antenna elements capable of being configured for beamforming. For example, an antenna array 410 may be referred to as a phased array because phase values and/or phase offsets of the antenna elements may be configured to form a beam, with different phase values and/or phase offsets being used for different beams (e.g., in different directions). In some examples, an antenna array 410 may be a fixed receive (RX) antenna array capable of only receiving communications while not transmitting communications. In some examples, an antenna array 410 may be a fixed transmit (TX) antenna array capable of only transmitting communications while not receiving communications. In some examples, an antenna array 410 may be capable of being configured to act as an RX antenna array or a TX antenna array (e.g., via a TX/RX switch and/or a MUX/DEMUX). The antenna arrays 410 may be capable of communicating using millimeter waves.

Gain component 420 includes a component capable of amplifying an input signal and outputting an amplified signal. For example, gain component 420 may include a power amplifier and/or a variable gain component. In some examples, gain component 420 may have variable gain control. The gain component 420 may connect to an RX antenna array (e.g., a first antenna array 410-1) and a TX antenna array (e.g., a second antenna array 410-2) such that an analog millimeter wave signal, received via the RX antenna array, can be amplified by the gain component 420 and output to the TX antenna array for transmission. In some examples, the level of amplification of the gain component 420 may be controlled by the controller 430.

Controller 430 includes a component capable of controlling one or more other components of the repeater 400. For example, the controller 430 may include a controller, a microcontroller, and/or a processor. In some examples, the controller 430 may control the gain component 420 by controlling a level of amplification or gain applied by the gain component 420 to an input signal. Additionally, or alternatively, the controller 430 may control an antenna array 3 410 by controlling a beamforming configuration for the antenna array 4 10 (e.g., one or more phase values for the antenna array 410, one or more phase offsets for the antenna array 410, one or more power parameters for the antenna array 410, one or more beamforming parameters for the antenna array 410, a TX beamforming configuration, and/or an RX beamforming configuration), by controlling whether the antenna array 410 acts as an RX antenna array or a TX antenna array (e.g., by configuring interaction and/or connections between the antenna array 410 and a MUX/DEMUX 450) Additionally, or alternatively, the controller 430 may power on or power off one or more components of repeater 400 (e.g., when a network node 110 does not need to use the repeater to serve UEs 120). In some examples, the controller 430 may control a timing of one or more of the above configurations.

Communication component 440 may include a component capable of wirelessly communicating with a network node 110 using a wireless technology other than millimeter wave (e.g., via a control interface). For example, the communication component 440 may communicate with the network node 110 using a personal area network (PAN) technology (e.g., Bluetooth or Bluetooth Low Energy (BLE)), a 4G or LTE radio access technology, a narrowband Internet of Things (NB-IoT) technology, a sub-6 GHz technology, a visible light communication technology, and/or the like. In some examples, the communication component 440 may use a lower frequency communication technology, and an antenna array 410 may use a higher frequency communication technology (e.g., millimeter wave). In some examples, an antenna array 410 may be used to transfer data between the repeater 400 and the network node 110, and the communication component 440 may be used to transfer control information between the repeater 400 and the network node 110 (e.g., a report, a configuration, and/or instructions to power on or power off one or more components).

MUX/DEMUX 450 may be used to multiplex and/or demultiplex communications received from and/or transmitted to an antenna array 410. For example, MUX/DEMUX 450 may be used to switch an RX antenna array to a TX antenna array.

In some examples, the repeater 400 does not include any components for digital signal processing. For example, in some examples, the repeater 400 does not include a digital signal processor, a baseband processor, a digital-to-analog converter (DAC), and/or an analog-to-digital converter (ADC). In this way, a cost to produce the repeater 400 may be reduced. Furthermore, latency may be reduced by eliminating digital processing of received millimeter wave signals prior to transmission of corresponding amplified millimeter wave signals.

In some examples, one or more antenna arrays 410, gain component 420, controller 430, communication component 440, and/or MUX/DEMUX 450 may perform one or more techniques associated with communicating with and/or configuring a repeater, as described in more detail elsewhere herein. For example, one or more components of repeater 400 may perform or direct operations of, for example, process 1000 of FIG. 10. In some examples, the repeater 400 includes a transceiver. The transceiver may include any combination of antenna arrays 410, gain component 420, controller 430, communication component 440, MUX/DEMUX 450, and/or a memory. The transceiver may be used by a processor (e.g., controller 430) and the memory to perform examples of any of the methods described herein, for example, as described with reference to FIG. 10. In some examples, the memory may comprise a non-transitory computer-readable medium storing one or more instructions for wireless communication. For example, the one or more instructions, when executed (e.g., directly, or after compiling, converting, and/or interpreting) by one or more processors of the repeater 400, may perform or direct operations of, for example, process 1000 of FIG. 10. In some examples, executing instructions may include running the instructions, converting the instructions, compiling the instructions, and/or interpreting the instructions.

In some examples, repeater 400 may include means for receiving, from a network node, information identifying a RIS configuration, wherein the RIS configuration includes one or more parameters for a time-varying control configuration associated with side-lobe suppression; means for forwarding, using the RIS configuration, one or more communications between the network node and a UE; or the like. In some examples, such means may include one or more components of repeater 400 described in connection with FIG. 4, such as one or more antenna arrays 410, gain component 420, controller 430, communication component 440, and/or MUX/DEMUX 4.

As indicated above, FIG. 4 is provided as an example. Other examples may differ from what is described with regard to FIG. 4. For example, repeater 400 may include additional components, fewer components, different components, or differently arranged components than those shown in FIG. 4. Furthermore, two or more components shown in FIG. 4 may be implemented within a single component, or a single component shown in FIG. 4 may be implemented as multiple components. Additionally, or alternatively, a set of components (e.g., one or more components) of repeater 400 may perform one or more functions described as being performed by another set of components of repeater 400.

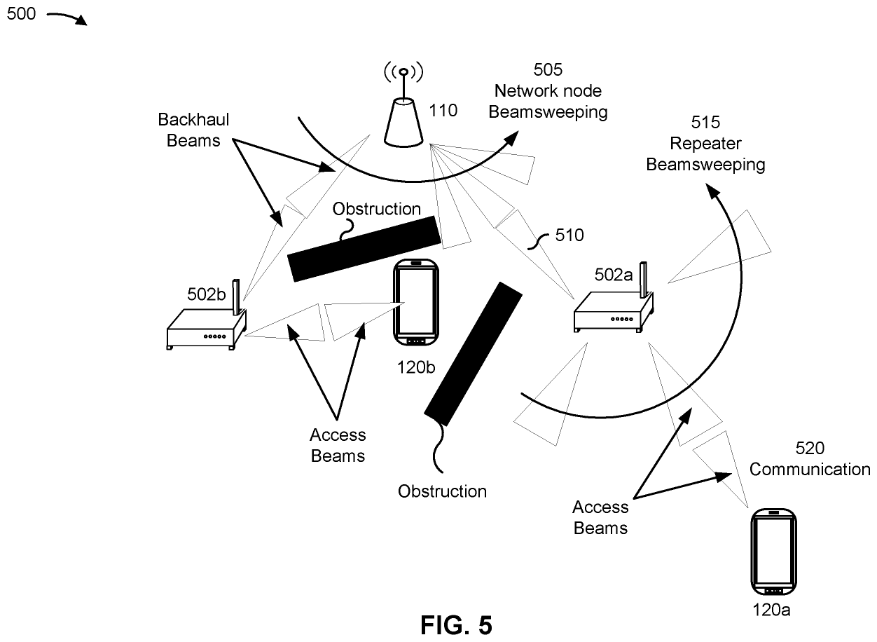

FIG. 5 is a diagram illustrating an example 500 of communicating using a repeater, in accordance with the present disclosure.

Because millimeter wave communications have a higher frequency and shorter wavelength than other types of radio waves used for communications (e.g., sub-6 GHz communications), millimeter wave communications may have shorter propagation distances and may be more easily blocked by obstructions than other types of radio waves. For example, a wireless communication that uses sub-6 GHz radio waves may be capable of penetrating a wall of a building or a structure to provide coverage to an area on an opposite side of the wall from a network node 110 that communicates using the sub-6 GHz radio waves. However, a millimeter wave may not be capable of penetrating the same wall (e.g., depending on a thickness of the wall and/or a material from which the wall is constructed). Some techniques and apparatuses described herein use a repeater 502 (which includes, in the example of FIG. 5, repeater 502a and repeater 502b) to increase the coverage area of a network node 110 and/or to extend coverage to UEs 120 (which include, in the example of FIG. 5, UE 120a and UE 120b) without line of sight to the network node 110 (e.g., due to an obstruction). In some examples, the repeater 502 may correspond to the RIS 170.

For example, as illustrated in the example of FIG. 5, an obstruction between UE 120b and network node 110 blocks or otherwise reduces the quality of a link between the network node 110 and UE 120b. Similarly, an obstruction between UE 120b and repeater 502a blocks or otherwise reduces the quality of a link between the repeater 502a and the UE 120b. However, no obstructions or fewer obstructions exist between repeater 502b and UE 120b, and, as such, it is possible that communications between repeater 502b and UE 120b will have a higher quality than communications between network node 110 and UE 120b or between repeater 502a and UE 120b. Furthermore, the repeater 502 described herein may be a layer 1 or an analog repeater, which is associated with a lower cost, less processing, and lower latency than a layer 2 or layer 3 repeater.

A repeater 502 (sometimes referred to herein as a repeater 502) may perform directional communication by using beamforming to communicate with a network node 110 via a first beam pair (e.g., a backhaul beam pair over a backhaul link with the network node 110) and to communicate with a UE 120 via a second beam pair (e.g., an access beam pair over an access link with the UE 120). For example, in example 500, repeater 502a can communicate with network node 110 via a first beam pair and can communicate with UE 120a via a second beam pair. Similarly, repeater 502b can communicate with network node 110 via a first beam pair and can communicate with UE 120a via a second beam pair. A beam pair may refer to a transmit (Tx) beam used by a first device for transmission and a receive (Rx) beam used by a second device for reception of information transmitted by the first device via the Tx beam.

As shown by reference number 505, a network node 110 may use a beamsweeping procedure to transmit communications via multiple beams over time (e.g., using time division multiplexing (TDM)). As shown by reference number 510, the repeater 502a may receive a communication via an Rx beam of the repeater 502a. As shown by reference number 515, the repeater 502a may relay each received communication via multiple Tx beams of the repeater 502a (e.g., using TDM). As used herein, relaying a communication may refer to transmitting the received communication (e.g., after amplifying the received communication) without decoding the received communication and/or without modifying information carried in the received communication. Alternatively, relaying a received communication may refer to transmitting the received communication after decoding the received communication and/or modifying information carried in the received communication. In some aspects, a received communication may be relayed using a different time resource, a different frequency resource, and/or a different spatial resource (e.g., a different beam) to transmit the communication as compared to a time resource, a frequency resource, and/or a spatial resource in which the communication was received. As shown by reference number 520, a UE 120a may receive a relayed communication. In some aspects, the UE 120a may generate a communication to be transmitted to the network node 110. The UE 120a may then transmit the communication to the repeater 502a for relaying to the network node 110.

As indicated above, FIG. 5 is provided as an example. Other examples may differ from what is described with regard to FIG. 5.

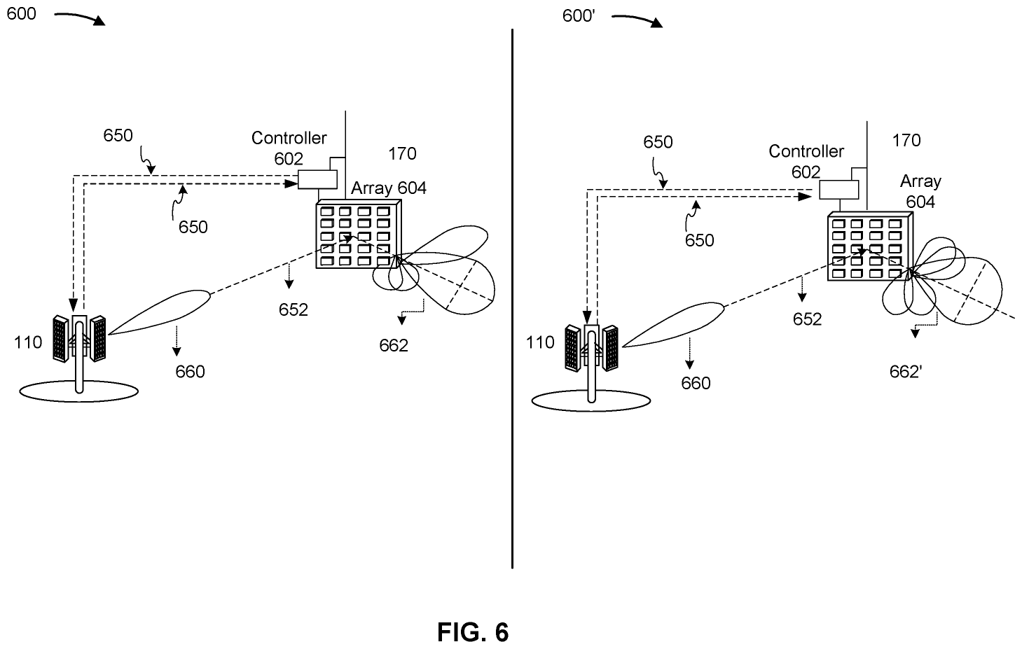

FIG. 6 is a diagram illustrating an example 600/600′ of beam patterns for communication using a repeater, in accordance with the present disclosure.

As shown in examples 600/600′, a network node 110 may have one or more communication links with a RIS 170. For example, the network node 110 may communicate with a RIS controller 602 via a control link 650. Additionally, or alternatively, the network node 110 may transmit signals to (or receive signals from) a RIS array 604 (e.g., for re-directed communication to a UE (not shown) via a directional link 652. When the network node transmits a beam 660 to the RIS array 604, the beam 660 may have a main lobe that the network node directs toward the RIS array 604. The network node 110 may use a relatively high level of gain in a desired direction and at a configured operating frequency to improve communications and/or sensing performance (e.g., relative to using a lower level of gain). As described above, transmitting a directional beam can result in interference being injected along one or more non-desired directions, which can disrupt communications and lead to sensing errors. As shown in example 600, a reflected beam pattern 662 may include a dominant main lobe and a side lobe with a significant amount of transmit power in a side-lobe that results in interference.

As shown in example 600′, when a taper is applied, the side-lobe in a reflected beam pattern 662′ can be suppressed (e.g., creating a more evenly spread reflected signal interference), but this may result in a loss of gain as well as main lobe broadening, which reduces communication and/or sensing performance. A taper may include a manipulation or configuration of an amplitude contribution of an individual element to the overall antenna response of the RIS array 604. Examples of taper techniques include Tseng-Cheng-Chebyshev tapering and Dolph-Chebyshev tapering, among other examples. A network node 110 may transmit at high levels of power to attempt to overcome the loss of gain and main lobe broadening, but communication and/or sensing performance is still non-optimal. A UE (not shown) that is transmitting to the network node 110 may not be capable of transmitting with high enough levels of power to avoid injecting interference and/or overcome gain reduction resulting from applying a taper. Moreover, amplitude control may not be available at some RISs to enable application of a taper. A dither can be applied for static RIS control by introducing random phase offsets, however, an amount of SLL suppression that is achieved in such techniques maybe based at least in part on a size of a RIS array, thereby reducing an applicability to all types of RISs.

As indicated above, FIG. 6 is provided as an example. Other examples may differ from what is described with respect to FIG. 6.

Some aspects described herein may enable SLL suppression in communication systems that use a RIS for repeated communication between other devices (e.g., a UE and a network node). For example, a RIS may apply an amplitude taper at an operation frequency using a relatively small reflection coefficient alphabet. Additionally, or alternatively, a RIS may spread reflected signal energy using dithering based at least in part on time offsets, thereby suppressing SLL. In some aspects, a network node may configure a RIS with parameterized codebooks that provide SLL suppression at different central frequencies. In some aspects, a network node and RIS may communicate to set a RIS configuration with a taper or other SLL suppression technique configured. In some aspects, a network node may set a taper for the RIS. In some aspects, a UE may be configured to interpret a set of power control commands to mitigate issues relating to interference at a RIS. In this way, by enabling RIS configuration and/or UE command interpretation, as described in more detail herein, devices in a network can communicate with reduced interference resulting from sidelobes of a RIS beam.

FIG. 7 is a diagram illustrating an example 700 associated with repeater interference management, in accordance with the present disclosure. As shown in FIG. 7, example 700 includes communication between a network node 110, a RIS 170, and a UE 120.

As further shown in FIG. 7, and by reference number 705, the network node 110 may configure the RIS 170. For example, the network node 110 may transmit configuration information to the RIS 170 to indicate a RIS configuration that the RIS 170 is to use for re-directing communications between the network node 110 and the UE 120. In some aspects, the network node 110 may transmit configuration information to the UE 120. For example, the network node 110 may transmit configuration information directly to the UE 120 or indirectly to the UE 120 (e.g., via the RIS 170). In this case, the configuration information may indicate one or more parameters that the UE 120 is to use to receive communications from the network node 110 via the RIS 170 or to transmit communications to the network node 110 via the RIS 170.

In some aspects, the network node 110 may configure a plurality of parametrized codebooks that are to be used for communications via the RIS 170. For example, a codebook may include one or more codewords (e.g., RIS configurations) and the codebook may be parametrized or identifiable by a set of identifiers. The set of identifiers may include an amount of SLL suppression at a central frequency, a difference (e.g., in decibels (dB)) of peak gain along a desired direction and a maximum side-lobe gain at a central frequency, or a set of codewords within a codebook. Additionally, or alternatively, the set of identifiers may include a frequency separation from a central frequency of one or more frequency harmonics, a peak gain of a reflected signal interference injected into the one or more frequency harmonics, or a gain value (e.g., an absolute gain value or a differential gain value relative to a central frequency peak gain), among other examples.

In some aspects, the set of parametrized codebooks, from which the network node 110 may select a RIS configuration for configuring the RIS 170, may be network node specific. For example, a network entity may configure the network node 110 with a set of codebooks and may configure another network node with a different set of codebooks. In this case, the network node 110 is configured with a particular set of codebooks based at least in part on a target incident signal direction and/or distance to the RIS 170. In some aspects, the network node 110 may determine the set of codebooks or create (or assign) a correspondence between codebooks, from which to select a RIS configuration for configuring the RIS 170, based at least in part on a spatial quasi-co-location (QCL) parameter. For example, an association among codewords from different codebooks may indicate corresponding beam pointing (e.g., main lobe peak gain) directions (e.g., within a neighborhood (threshold range) of angular directions) for the different codebooks.

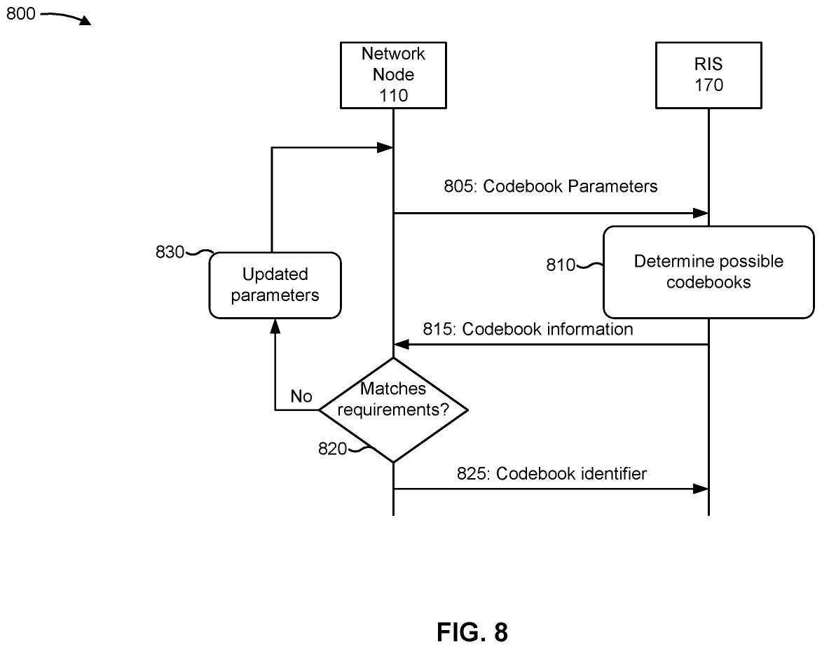

Based at least in part on the network node 110 being configured with a plurality of codebooks and selecting a code book and code word from the plurality of codebooks, the network node 110 may transmit signaling to the RIS 170 (e.g., to a RIS controller) to identify the selected codebook and a selected codeword from the selected codebook. The RIS 170 may identify the selected codebook and the selected codeword and configure one or more parameters, such as one or more weights or offsets that are applied to different antenna elements of the RIS 170, based at least in part on the selected codebook and the selected codeword. In some aspects, the network node 110 and the RIS 170 may complete a negotiation procedure to determine the codebook and codeword. For example, as described in more detail in FIG. 8, the network node 110 may indicate a set of parameters, receive feedback identifying possible codebooks, determine whether a codeword of a codebook of the possible codebooks satisfies a set of requirements or thresholds, and may indicate a selected codeword of a selected codebook.

In some aspects, the network node 110 may receive (e.g., from a network entity) configuration information regarding the RIS 170 and may use the information regarding the RIS 170 to configure the RIS 170. For example, the network node 110 may receive information identifying an element grouping of RIS antenna elements or a grouping configuration associated therewith. A grouping configuration may include a partition of RIS elements into one or more groups. Each element within a group may have the same applied control (e.g., time-varying control parameters, such as reflection coefficients, positive and negative state durations, time-offsets, among other examples, in each period). Additionally, or alternatively, the network node 110 may receive (e.g., as absolute values or differential values with respect to a period duration) information identifying an alphabet or a codebook for a quantized time-offset or an alphabet for a quantized (e.g., negated state) time duration for coefficients applied to reflections at antenna elements of the RIS 170. Additionally, or alternatively, the network node 110 may receive information identifying a switching speed or a dwell-time constraint associated with applying coefficients to reflections at antenna elements of the RIS 170. Based at least in part on receiving information regarding the RIS 170, the network node 110 may select a codebook for the RIS 170.

Additionally, or alternatively, the network node 110 may receive RIS capability information (e.g., from a network entity). For example, the network node 110 may receive information identifying a reflection coefficient alphabet and a pre-set dither pattern of the RIS 170. Additionally, or alternatively, the network node 110 may receive information identifying an element grouping capability and/or a capability for one or more grouping configurations. Additionally, or alternatively, the network node 110 may receive information identifying a capability of an alphabet for a quantized time offset and/or an alphabet for a set of quantized durations for applying a set of coefficients. Additionally, or alternatively, the network node 110 may receive information identifying a capability for a switching speed or a dwell time constraint.

In some aspects, the network node 110 may transmit a RIS configuration identifying a particular set of parameters for the RIS 170. For example, the network node 110 may transmit a RIS configuration explicitly setting one or more parameters for a time-varying periodic RIS control with amplitude tampering via unequal positive-negative state durations and time offsets (e.g., with a Tseng-Cheng-Chebyshev or Dolph-Chebyshev taper). In this case, the RIS configuration may include information identifying a codeword from a codebook, a periodicity (e.g., a period duration to be used for applying, among other examples, time-varying control), a grouping configuration (e.g., a grouping or groupings of antenna elements that are to have common sets of parameters or coefficients applied), a time duration (e.g., a negated state time duration from a quantized time duration codebook) on a per-group basis (e.g., to realize an amplitude taper on a central frequency), or a time offset (e.g., from a quantized time offset codebook) on a per-group basis (e.g., to realize a dither capability on a harmonic).

As an example of time-varying periodic RIS control, which may be configured with a RIS configuration, the RIS 170 may use a time varying control input Γ(t) to control a reflection coefficient of each RIS element, where:

$$Γ ( t ) = \{ \begin{matrix}1 , 0 < t < {t}_{o} or τ + {t}_{0} < t < {T}_{o} \\ - 1 , {t}_{0} \leq t \leq τ + {t}_{0}\end{matrix} ,$$

$$Γ ( t ) = {\sum }_{k} {a}_{k} exp ( j 2 π {kf}_{o} t )$$

and where, t represents a time at which the time varying control input is applied, to represents amount of time offset, r represents a negated state duration for control states, Tₒ represents a periodicity for time-varying control states, ak is the kth harmonic coefficient, f₀=1/Tₒ is an periodic frequency value, and j=\sqrt{−1} V is an imaginary number. The kth harmonic coefficient aₖ can be determined as:

$${a}_{k} = \{ \begin{matrix}1 - \frac{2 τ}{{T}_{o}} , k = 0 & \\ - 2 \frac{τ}{{T}_{o}} sin c ( \frac{k τ π}{{T}_{o}} ) exp ( - j 2 π {kf}_{o} ( {t}_{o} + τ / 2 ) ) , & k = \pm 1 , \pm 2 , \pm 3 …\end{matrix} ;$$

where sinc(x) represents sin(x)/x. In this case, reflection coefficient phases [symbol] are used to achieve beam pointing to a configured direction at an operating frequency. For each RIS element, the same period Tₒ is selected, but with a different time offset tₒ^{pq} and negated state duration τ_{pq} for a RIS element (p, q). Accordingly, an effective time-varying reflection coefficient for the RIS element (p, q) can be represented as \tilde{Γ}^{pq}Γ^{pq}(t) and, at an operating frequency (e.g., corresponding to the zeroth harmonic), amplitude control can be represented as {\tilde{Γ}^{pq}(1−2τ^{pq}/Tₒ)} with weighting (e.g., tapering) applied for side-lobe level reduction. At harmonics {f_{c}+kfₒ}ₖ, where fc is the operating frequency, the RIS 170 can apply dither control with time-offsets {exp(−jπkfₒtₒ^{pq})}. Accordingly, a time-varying periodic RIS control of a reflected signal R(t) can be represented as:

$$R ( t ) = exp ( j 2 π {f}_{c} t ) {\sum }_{p , q} {G}^{p , q} ( θ , ϕ ) {\tilde{Γ}}^{pq} {Γ}^{pq} ( t ) = {\sum }_{k , p , q} {G}^{p , q} ( θ , ϕ ) {\tilde{Γ}}^{pq} {a}_{k} exp ( j 2 π ( {f}_{c} + {kf}_{o} ) t )$$

where θ and ϕ are angular coefficients.

As an example of tapered reflection coefficients, which may be configured by a RIS configuration, a target tapered reflection coefficient {w^{pq}Γ_{unc}^{pq}} for each RIS element (p, q) can be represented as a linear combination of coefficients representing time-durations in each period for which a corresponding reflection coefficient is to be applied:

$${w}^{pq} {Γ}_{unc}^{pq} \approx {τ}_{1}^{pq} {Γ}_{1}^{pq} + {τ}_{2}^{pq} {Γ}_{2}^{pq} + … + {τ}_{m}^{pq} {Γ}_{m}^{pq} ;$$

$$0 \leq {τ}_{i}^{pq} \leq 1 ,$$

$${Γ}_{i}^{pq} ∈ Ω ∀ i ,$$

$${\sum }_{i} {τ}_{i}^{pq} = 1$$

where τᵢ^{pq} represents a time duration, Γᵢ^{pq} represents a reflection coefficient, and m represents a quantity of switches (e.g., between states) that are to occur within each time period. Each selected element Γᵢ^{pq} from a reflection coefficient alphabet can have an associated duration τᵢ^{pq}>δ, where δ represents a settling time constraint, thereby restricting a quantity of switches that are to be performed per time period. Additionally, or alternatively, a quantity of durations can be constrained to a quantized alphabet, thereby constraining the set of target tapered reflection coefficients for the set of RIS elements of a RIS 170. In some aspects, time-offsets, as described above, can be applied with tapered reflection coefficients. Although some aspects are described in terms of a set of equations or relationships for determining coefficients, it is contemplated that are other approaches are possible, such as a table of coefficients or a static configuration of a set of coefficients.

The network node 110 may transmit a RIS configuration explicitly setting one or more parameters for a set of constraints applied to a set of tapered reflection coefficients. In this case, the RIS configuration may include information identifying a periodicity of control (e.g., a period duration), a grouping configuration, a per-group quantity of switches in each period, a per-group set of ordered durations and reflection coefficients per period, or a per-group set of time-offsets.

In some aspects, the network node 110 may configure the UE 120 to account for RIS-assisted uplink (e.g., to account for the RIS configuration that the RIS 170 is to apply for uplink transmissions from the UE 120). For example, the network node 110 may configure a set of look-up tables, for interpreting power control commands, that are specific to use of the RIS 170 (e.g., to account for directivity and SLL suppression at the RIS 170). The power control commands may identify one or more adjustment steps or states for adjusting power control and may correspond to entries in a look-up table (e.g., an absolute value or accumulative look-up table) indicating a quantity of dB power increase or decrease to apply for each power control command. Although some aspects are described in terms of a look-up table, other techniques for interpreting power control commands, such as algorithmic approaches or other types of data structures, are contemplated.

In some aspects, the network node 110 may configure the UE 120 via a particular type of signaling. For example, the network node 110 may use semi-static signaling (e.g., RRC signaling) to indicate a set of look-up tables to use with RIS-assisted uplink. Additionally, or alternatively, the network node 110 may use semi-static or dynamic signaling to indicate which look-up table, of a set of look-up tables, the UE 120 is to use. For example, based at least in part on selecting and configuring a particular RIS configuration for the RIS 170, the network node 110 may select a corresponding look-up table with power control command steps that are appropriate for one or more parameters of the particular RIS configuration. The network node 110 may determine the corresponding look-up table based at least in part on information indicating the correspondence or signaling from a network entity. Additionally, or alternatively, the network node 110 may transmit semi-static signaling identifying a bandwidth threshold or an interpretation field, such that the UE 120 can use a specific look-up table to interpret transmit power control command adjustment bits for uplink physical uplink shared channel grants with a contiguous bandwidth that satisfies the bandwidth threshold. Although some aspects are described herein in terms of signaling configurations by a network entity or a network node, among other examples, it is contemplated that such configurations are statically defined in a specification or standard rather than being signaled.

As further shown in FIG. 7, and by reference number 710, the network node 110 may communicate with the UE 120 via the RIS 170. For example, the RIS 170 may receive a communication from the network node 110 and re-direct the communication to the UE 120, or vice versa, in accordance with the RIS configuration. In this case, the RIS 170 may apply one or more weights or offsets to one or more reflections by one or more antenna elements of the RIS 170 to control SLL suppression and avoid causing excess interference from side-lobes of a reflected beam. Additionally, or alternatively, the UE 120 may use a signaled configuration for, for example, uplink transmission to the network node 110 via the RIS 170.

As indicated above, FIG. 7 is provided as an example. Other examples may differ from what is described with respect to FIG. 7.

FIG. 8 is a diagram illustrating an example 800 associated with repeater interference management, in accordance with the present disclosure. As shown in FIG. 8, example 800 includes communication between a network node 110, a RIS 170, and a UE 120.

As further shown in FIG. 8, and by reference number 805, the network node 110 may transmit information identifying a set of codebook parameters. For example, the network node 110 may transmit information identifying a range or span of a reflected or refracted angle, for the RIS 170 to facilitate communication, at a central frequency. Additionally, or alternatively, the network node 110 may transmit information identifying an amount of SLL suppression at the central frequency. Additionally, or alternatively, the network node 110 may transmit information identifying a frequency separation of one or more dominant harmonics and/or a maximum interference level or gain at the one or more dominant harmonics. Additionally, or alternatively, the network node 110 may transmit information identifying an incident signal direction from the network node 110 and/or a distance between the network node 110 and the RIS 170. Additionally, or alternatively, the network node 110 may transmit information identifying a cardinality (e.g., a quantity of codewords) that can be used for a codebook. In this way, the network node 110 identifies a set of requirements (or thresholds) that a codebook is to satisfy to be selected.

As further shown in FIG. 8, and by reference number 810, the RIS 170 may determine a set of possible codebooks. As shown by reference number 815, the RIS 170 may transmit codebook information identifying the set of possible codebooks. For example, the RIS 170 may identify, from a set of parametrized codebooks with which the RIS 170 has been configured, one or more codebooks that satisfy the set of codebook parameters (e.g., a set of requirements or thresholds that the network node 110 has indicated a codebook is to satisfy). In some aspects, the RIS 170 may indicate one or more parameters of the set of possible codebooks. For example, for each possible codebook, the RIS 170 may indicate an achieved SLL suppression at a central frequency, a frequency separation or maximum injected interference for one or more dominant harmonics, or a frequency separation of harmonics with injected interference above a threshold (e.g., relative to a peak gain at a center frequency), among other examples.

As further shown in FIG. 8, and by reference number 820, the network node 110 may determine whether a codebook, of the set of possible codebooks, and a codeword thereof satisfies a set of requirements associated with the set of parameters. For example, the network node 110 may confirm whether an identified codebook can satisfy one or more communication requirements. The one or more communication requirements may include a set of traffic or user profiles, a set of channel condition requirements,

As further shown in FIG. 8, and by reference number 825, based at least in part on the set of possible codebooks including a codebook and codeword that satisfies the set of requirements, the network node 110 may transmit information identifying a codebook. For example, the network node 110 may transmit information identifying a RIS configuration, which may indicate a selected codebook and a selected codeword for the RIS 170, as described above. In contrast, as shown by reference number 830, when there is not a codebook and codeword that satisfies the set of requirements, the network node 110 may update the set of codebook parameters and return to transmitting the updated set of codebook parameters, as shown by reference number 805, to further negotiate a codebook and codeword for configuring the RIS 170.

As indicated above, FIG. 8 is provided as an example. Other examples may differ from what is described with respect to FIG. 8.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with RIS interference management.

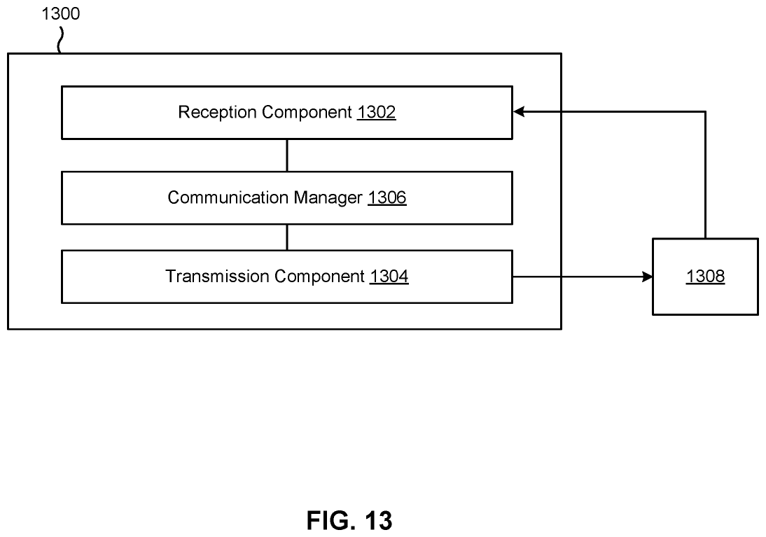

As shown in FIG. 9, in some aspects, process 900 may include transmitting, to a RIS, information identifying a RIS configuration, wherein the RIS configuration includes one or more parameters for a time-varying control configuration associated with side-lobe suppression (block 910). For example, the network node (e.g., using transmission component 1304 and/or communication manager 1306, depicted in FIG. 13) may transmit, to a RIS, information identifying a RIS configuration, wherein the RIS configuration includes one or more parameters for a time-varying control configuration associated with side-lobe suppression, as described above.

As further shown in FIG. 9, in some aspects, process 900 may include communicating, via the RIS and using the RIS configuration, with a UE (block 920). For example, the network node (e.g., using reception component 1302, transmission component 1304, and/or communication manager 1306, depicted in FIG. 13) may communicate, via the RIS and using the RIS configuration, with a UE, as described above.

Process 900 may include additional aspects, such as any single aspect or any combination of aspects described below and/or in connection with one or more other processes described elsewhere herein.

In a first aspect, transmitting the information identifying the RIS configuration comprises transmitting information identifying a codebook of a set of codebooks, and wherein the codebook includes one or more codewords associated with the one or more parameters of the time-varying control configuration.

In a second aspect, alone or in combination with the first aspect, the RIS configuration is based at least in part on a parameter of the network node, the parameter of the network node including at least one of a device identity parameter, a target incident signal direction parameter, or a distance parameter.

In a third aspect, alone or in combination with one or more of the first and second aspects, transmitting the information identifying the RIS configuration comprises transmitting using a spatial quasi-colocation parameter, wherein the RIS configuration is based at least in part on the spatial quasi-colocation parameter.

In a fourth aspect, alone or in combination with one or more of the first through third aspects, the one or more parameters include at least one of an SLL suppression parameter, a frequency separation parameter, an interference level parameter, a directional parameter, an angular parameter, or a cardinality parameter.

In a fifth aspect, alone or in combination with one or more of the first through fourth aspects, process 900 includes receiving information identifying one or more codebooks supported by the RIS, and transmitting information identifying a selection of a codebook, of the one or more codebooks, based at least in part on the information identifying the one or more codebooks supported by the RIS.

In a sixth aspect, alone or in combination with one or more of the first through fifth aspects, process 900 includes transmitting first update information based at least in part on the information identifying the one or more codebooks supported by the RIS, and receiving second update information identifying another one or more codebooks supported by the RIS in connection with the first update information, and wherein transmitting the information identifying the selection comprises transmitting information identifying the selection from the other one or more codebooks.

In a seventh aspect, alone or in combination with one or more of the first through sixth aspects, process 900 includes receiving information identifying one or more attributes of a codebook supported by the RIS, wherein the one or more attributes includes at least one of a main-lobe directional attribute, a beam width attribute, a peak gain attribute, a side-lobe gain attribute, or a side-lobe directional attribute, and wherein transmitting information identifying the RIS configuration comprises transmitting information identifying a selection of the codebook based at least in part on the one or more attributes.

In an eighth aspect, alone or in combination with one or more of the first through seventh aspects, process 900 includes receiving capability information from the RIS, wherein the capability information includes information identifying at least one of an element grouping, an alphabet, a codebook, a switching speed, a dwell-time, a reflection coefficient, or a dither pattern, wherein transmitting information identifying the RIS configuration comprises transmitting information identifying a selection of the codebook based at least in part on the capability information.

In a ninth aspect, alone or in combination with one or more of the first through eighth aspects, process 900 includes communicating with the RIS to determine at least one of a codeword, a periodicity, a group configuration, a per-group parameter, a time duration, or a time offset, and wherein transmitting information identifying the RIS configuration comprises transmitting information identifying a selection of a codebook based at least in part on communicating with the RIS.

In a tenth aspect, alone or in combination with one or more of the first through ninth aspects, process 900 includes transmitting, to the UE, information identifying one or more power control configuration parameters for communication via the RIS, and wherein communicating with the UE comprises communicating in accordance with the one or more power control configuration parameters.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a RIS or an apparatus of a RIS, in accordance with the present disclosure. Example process 1000 is an example where the apparatus or the RIS (e.g., RIS 170) performs operations associated with RIS interference management.

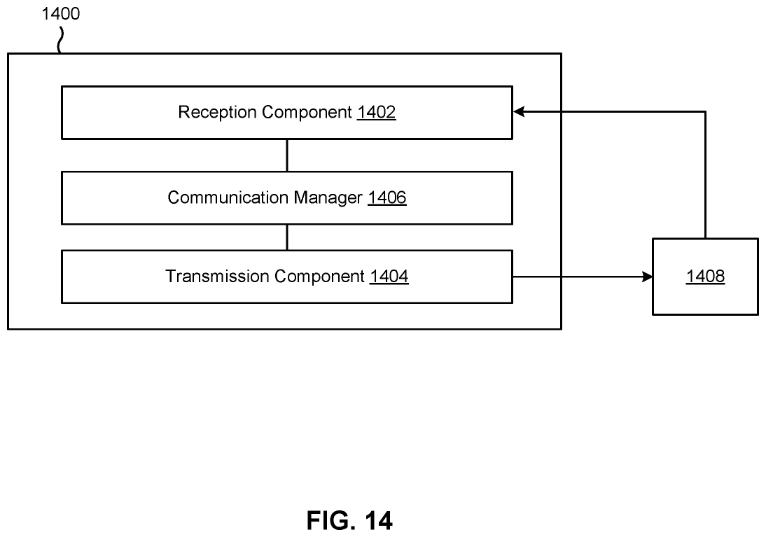

As shown in FIG. 10, in some aspects, process 1000 may include receiving, from a network node, information identifying a RIS configuration, wherein the RIS configuration includes one or more parameters for a time-varying control configuration associated with side-lobe suppression (block 1010). For example, the RIS (e.g., using reception component 1402 and/or communication manager 1406, depicted in FIG. 14) may receive, from a network node, information identifying a RIS configuration, wherein the RIS configuration includes one or more parameters for a time-varying control configuration associated with side-lobe suppression, as described above.

As further shown in FIG. 10, in some aspects, process 1000 may include forwarding, using the RIS configuration, one or more communications between the network node and a UE (block 1020). For example, the RIS (e.g., using reception component 1402, transmission component 1404, and/or communication manager 1406, depicted in FIG. 14) may forward, using the RIS configuration, one or more communications between the network node and a UE, as described above.

Process 1000 may include additional aspects, such as any single aspect or any combination of aspects described below and/or in connection with one or more other processes described elsewhere herein.

In a first aspect, receiving the information identifying the RIS configuration comprises receiving information identifying a codebook of a set of codebooks, and wherein the codebook includes one or more codewords associated with the one or more parameters of the time-varying control configuration.

In a second aspect, alone or in combination with the first aspect, the RIS configuration is based at least in part on a parameter of the network node, the parameter of the network node including at least one of a device identity parameter, a target incident signal direction parameter, or a distance parameter.

In a third aspect, alone or in combination with one or more of the first and second aspects, receiving the information identifying the RIS configuration comprises receiving using a spatial quasi-colocation parameter, wherein the RIS configuration is based at least in part on the spatial quasi-colocation parameter.

In a fourth aspect, alone or in combination with one or more of the first through third aspects, the one or more parameters include at least one of a SLL suppression parameter, a frequency separation parameter, an interference level parameter, a directional parameter, an angular parameter, or a cardinality parameter.

In a fifth aspect, alone or in combination with one or more of the first through fourth aspects, process 1000 includes transmitting information identifying one or more codebooks supported by the RIS, and receiving information identifying a selection of a codebook, of the one or more codebooks, based at least in part on the information identifying the one or more codebooks supported by the RIS.

In a sixth aspect, alone or in combination with one or more of the first through fifth aspects, process 1000 includes receiving first update information based at least in part on the information identifying the one or more codebooks supported by the RIS, and transmitting second update information identifying another one or more codebooks supported by the RIS in connection with the first update information, and wherein receiving the information identifying the selection comprises receiving information identifying the selection from the other one or more codebooks.

In a seventh aspect, alone or in combination with one or more of the first through sixth aspects, process 1000 includes transmitting information identifying one or more attributes of a codebook supported by the RIS, wherein the one or more attributes includes at least one of a main-lobe directional attribute, a beam width attribute, a peak gain attribute, a side-lobe gain attribute, or a side-lobe directional attribute, and wherein receiving information identifying the RIS configuration comprises receiving information identifying a selection of the codebook based at least in part on the one or more attributes.

In an eighth aspect, alone or in combination with one or more of the first through seventh aspects, process 1000 includes transmitting capability information, wherein the capability information includes information identifying at least one of an element grouping, an alphabet, a codebook, a switching speed, a dwell-time, a reflection coefficient, or a dither pattern, wherein receiving information identifying the RIS configuration comprises receiving information identifying a selection of the codebook based at least in part on the capability information.

In a ninth aspect, alone or in combination with one or more of the first through eighth aspects, process 1000 includes communicating with the network node to determine at least one of a codeword, a periodicity, a group configuration, a per-group parameter, a time duration, or a time offset, and wherein receiving information identifying the RIS configuration comprises receiving information identifying a selection of a codebook based at least in part on communicating with the network node.

In a tenth aspect, alone or in combination with one or more of the first through ninth aspects, process 1000 includes transmitting, to the UE, information identifying one or more power control configuration parameters for communication via the RIS, and wherein forwarding the one or more communications comprises forwarding the one or more communications in accordance with the one or more power control configuration parameters based at least in part on transmitting the information identifying the one or more power control configuration parameters.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with RIS interference management.

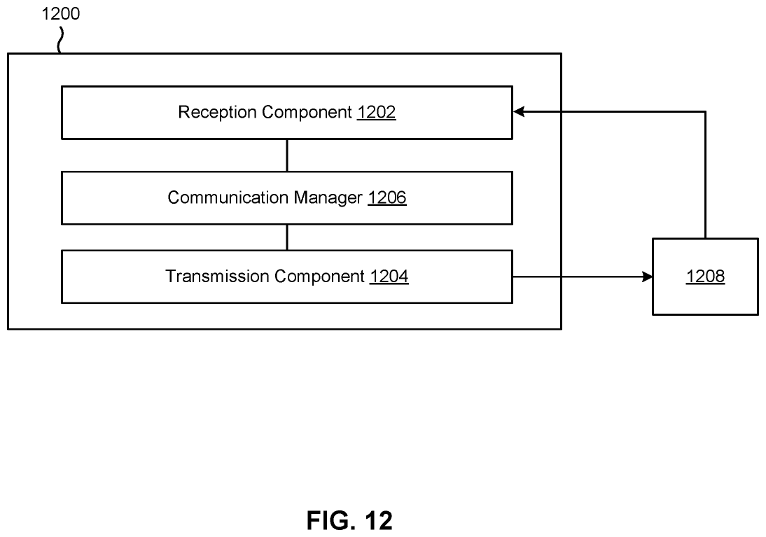

As shown in FIG. 11, in some aspects, process 1100 may include receiving, from a network node and via a RIS, information identifying one or more power control configuration parameters for communication with the network node via the RIS, wherein the power control configuration parameters relate to a RIS configuration that includes one or more parameters for a time-varying control configuration associated with side-lobe suppression (block 1110). For example, the UE (e.g., using reception component 1202 and/or communication manager 1206, depicted in FIG. 12) may receive, from a network node and via a RIS, information identifying one or more power control configuration parameters for communication with the network node via the RIS, wherein the power control configuration parameters relate to a RIS configuration that includes one or more parameters for a time-varying control configuration associated with side-lobe suppression, as described above.

As further shown in FIG. 11, in some aspects, process 1100 may include communicating, via the RIS and using the one or more power control configuration parameters, with the network node (block 1120). For example, the UE (e.g., using reception component 1202, transmission component 1204, and/or communication manager 1206, depicted in FIG. 12) may communicate, via the RIS and using the one or more power control configuration parameters, with the network node, as described above.

Process 1100 may include additional aspects, such as any single aspect or any combination of aspects described below and/or in connection with one or more other processes described elsewhere herein.

In a first aspect, the one or more power control configuration parameters includes an indication in an entry of a power control look-up table, of a set of look-up tables, wherein the power control look-up table is configured for RIS-assisted uplink.

In a second aspect, alone or in combination with the first aspect, process 1100 includes receiving, from the network node and via semi-static signaling, at least one of information identifying the set of look-up tables, the indication of the entry of the power control look-up table, a selection of the power control look-up table from the set of look-up tables, a side-lobe suppression characteristic, a bandwidth threshold, or a configuration for interpreting transmit power control commands.

In a third aspect, alone or in combination with one or more of the first and second aspects, the one or more power control configuration parameters includes an indication of an adjustment step for adjusting a power control.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 7-8. Additionally, or alternatively, the apparatus 1200 may be configured to perform one or more processes described herein, such as process 1100 of FIG. 11. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, from a network node and via a RIS, information identifying one or more power control configuration parameters for communication with the network node via the RIS, wherein the power control configuration parameters relate to a RIS configuration that includes one or more parameters for a time-varying control configuration associated with side-lobe suppression. The reception component 1202 and/or the transmission component 1204 may communicate, via the RIS and using the one or more power control configuration parameters, with the network node. The reception component 1202 may receive, from the network node and via semi-static signaling, at least one of information identifying the set of look-up tables, the indication of the entry of the power control look-up table, a selection of the power control look-up table from the set of look-up tables, a side-lobe suppression characteristic, a bandwidth threshold, or a configuration for interpreting transmit power control commands.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 7-8. Additionally, or alternatively, the apparatus 1300 may be configured to perform one or more processes described herein, such as process 900 of FIG. 9. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may transmit, to a RIS, information identifying a RIS configuration, wherein the RIS configuration includes one or more parameters for a time-varying control configuration associated with side-lobe suppression. The reception component 1302 and/or the transmission component 1304 may communicate, via the RIS and using the RIS configuration, with a UE. The reception component 1302 may receive information identifying one or more codebooks supported by the RIS. The transmission component 1304 may transmit information identifying a selection of a codebook, of the one or more codebooks, based at least in part on the information identifying the one or more codebooks supported by the RIS.

The transmission component 1304 may transmit first update information based at least in part on the information identifying the one or more codebooks supported by the RIS.

The reception component 1302 may receive second update information identifying another one or more codebooks supported by the RIS in connection with the first update information. The reception component 1302 may receive information identifying one or more attributes of a codebook supported by the RIS wherein the one or more attributes includes at least one of: a main-lobe directional attribute, a beam width attribute, a peak gain attribute, a side-lobe gain attribute, or a side-lobe directional attribute. The reception component 1302 may receive capability information from the RIS wherein the capability information includes information identifying at least one of: an element grouping, an alphabet, a codebook, a switching speed, a dwell-time, a reflection coefficient, or a dither pattern. The communication manager 1306 may communicate with the RIS to determine at least one of a codeword, a periodicity, a group configuration, a per-group parameter, a time duration, or a time offset. The transmission component 1304 may transmit, to the UE, information identifying one or more power control configuration parameters for communication via the RIS.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a RIS, or a RIS may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 172 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 7-8. Additionally, or alternatively, the apparatus 1400 may be configured to perform one or more processes described herein, such as process 1000 of FIG. 10. In some aspects, the apparatus 1400 and/or one or more components shown in FIG. 14 may include one or more components of the RIS described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the RIS described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the RIS described in connection with FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive, from a network node, information identifying a RIS configuration, wherein the RIS configuration includes one or more parameters for a time-varying control configuration associated with side-lobe suppression. The communication manager 1406 may forward, using the RIS configuration, one or more communications between the network node and a UE.

The transmission component 1404 may transmit information identifying one or more codebooks supported by the RIS. The reception component 1402 may receive information identifying a selection of a codebook, of the one or more codebooks, based at least in part on the information identifying the one or more codebooks supported by the RIS. The reception component 1402 may receive first update information based at least in part on the information identifying the one or more codebooks supported by the RIS. The transmission component 1404 may transmit second update information identifying another one or more codebooks supported by the RIS in connection with the first update information. The transmission component 1404 may transmit information identifying one or more attributes of a codebook supported by the RIS wherein the one or more attributes includes at least one of: a main-lobe directional attribute, a beam width attribute, a peak gain attribute, a side-lobe gain attribute, or a side-lobe directional attribute.

The transmission component 1404 may transmit capability information wherein the capability information includes information identifying at least one of: an element grouping, an alphabet, a codebook, a switching speed, a dwell-time, a reflection coefficient, or a dither pattern. The communication manager 1406 may communicate with the network node to determine at least one of a codeword, a periodicity, a group configuration, a per-group parameter, a time duration, or a time offset. The transmission component 1404 may forward, to the UE, information identifying one or more power control configuration parameters for communication via the RIS.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:
Aspect 1: A method of wireless communication performed by a network node, comprising: transmitting, to a reconfigurable intelligent surface (RIS), information identifying a RIS configuration, wherein the RIS configuration includes one or more parameters for a time-varying control configuration associated with side-lobe suppression; and communicating, via the RIS and using the RIS configuration, with a user equipment (UE).
Aspect 2: The method of Aspect 1, wherein transmitting the information identifying the RIS configuration comprises: transmitting information identifying a codebook of a set of codebooks, and wherein the codebook includes one or more codewords associated with the one or more parameters of the time-varying control configuration.
Aspect 3: The method of any of Aspects 1-2, wherein the RIS configuration is based at least in part on a parameter of the network node, the parameter of the network node including at least one of: a device identity parameter, a target incident signal direction parameter, or a distance parameter.
Aspect 4: The method of any of Aspects 1-3, wherein transmitting the information identifying the RIS configuration comprises: transmitting using a spatial quasi-colocation parameter, wherein the RIS configuration is based at least in part on the spatial quasi-colocation parameter.
Aspect 5: The method of any of Aspects 1-4, wherein the one or more parameters include at least one of: a side-lobe-level (SLL) suppression parameter, a frequency separation parameter, an interference level parameter, a directional parameter, an angular parameter, or a cardinality parameter.
Aspect 6: The method of any of Aspects 1-5, further comprising: receiving information identifying one or more codebooks supported by the RIS; and transmitting information identifying a selection of a codebook, of the one or more codebooks, based at least in part on the information identifying the one or more codebooks supported by the RIS.
Aspect 7: The method of Aspect 6, further comprising: transmitting first update information based at least in part on the information identifying the one or more codebooks supported by the RIS; and receiving second update information identifying another one or more codebooks supported by the RIS in connection with the first update information; and wherein transmitting the information identifying the selection comprises: transmitting information identifying the selection from the other one or more codebooks. wherein transmitting the information identifying the selection comprises: transmitting information identifying the selection from the other one or more codebooks.
Aspect 8: The method of any of Aspects 1-7, further comprising: receiving information identifying one or more attributes of a codebook supported by the RIS, wherein the one or more attributes includes at least one of: a main-lobe directional attribute, a beam width attribute, a peak gain attribute, a side-lobe gain attribute, or a side-lobe directional attribute; and wherein transmitting information identifying the RIS configuration comprises: transmitting information identifying a selection of the codebook based at least in part on the one or more attributes.
Aspect 9: The method of any of Aspects 1-8, further comprising: receiving capability information from the RIS, wherein the capability information includes information identifying at least one of: an element grouping, an alphabet, a codebook, a switching speed, a dwell-time, a reflection coefficient, or a dither pattern; wherein transmitting information identifying the RIS configuration comprises: transmitting information identifying a selection of the codebook based at least in part on the capability information.
Aspect 10: The method of any of Aspects 1-9, further comprising: communicating with the RIS to determine at least one of: a codeword, a periodicity, a group configuration, a per-group parameter, a time duration, or a time offset; and wherein transmitting information identifying the RIS configuration comprises: transmitting information identifying a selection of a codebook based at least in part on communicating with the RIS.
Aspect 11: The method of any of Aspects 1-10, further comprising: transmitting, to the UE, information identifying one or more power control configuration parameters for communication via the RIS; and wherein communicating with the UE comprises: communicating in accordance with the one or more power control configuration parameters.
Aspect 12: A method of wireless communication performed by a reconfigurable intelligent surface (RIS), comprising: receiving, from a network node, information identifying a RIS configuration, wherein the RIS configuration includes one or more parameters for a time-varying control configuration associated with side-lobe suppression; and forwarding, using the RIS configuration, one or more communications between the network node and a user equipment (UE).
Aspect 13: The method of Aspect 12, wherein receiving the information identifying the RIS configuration comprises: receiving information identifying a codebook of a set of codebooks, and wherein the codebook includes one or more codewords associated with the one or more parameters of the time-varying control configuration.
Aspect 14: The method of any of Aspects 12-13, wherein the RIS configuration is based at least in part on a parameter of the network node, the parameter of the network node including at least one of: a device identity parameter, a target incident signal direction parameter, or a distance parameter.
Aspect 15: The method of any of Aspects 12-14, wherein receiving the information identifying the RIS configuration comprises: receiving using a spatial quasi-colocation parameter, wherein the RIS configuration is based at least in part on the spatial quasi-colocation parameter.
Aspect 16: The method of any of Aspects 12-15, wherein the one or more parameters include at least one of: a side-lobe-level (SLL) suppression parameter, a frequency separation parameter, an interference level parameter, a directional parameter, an angular parameter, or a cardinality parameter.
Aspect 17: The method of any of Aspects 12-16, further comprising: transmitting information identifying one or more codebooks supported by the RIS; and receiving information identifying a selection of a codebook, of the one or more codebooks, based at least in part on the information identifying the one or more codebooks supported by the RIS.
Aspect 18: The method of Aspect 17, further comprising: receiving first update information based at least in part on the information identifying the one or more codebooks supported by the RIS; and transmitting second update information identifying another one or more codebooks supported by the RIS in connection with the first update information; and wherein receiving the information identifying the selection comprises: receiving information identifying the selection from the other one or more codebooks.
Aspect 19: The method of any of Aspects 12-18, further comprising: transmitting information identifying one or more attributes of a codebook supported by the RIS, wherein the one or more attributes includes at least one of: a main-lobe directional attribute, a beam width attribute, a peak gain attribute, a side-lobe gain attribute, or a side-lobe directional attribute; and wherein receiving information identifying the RIS configuration comprises: receiving information identifying a selection of the codebook based at least in part on the one or more attributes.
Aspect 20: The method of any of Aspects 12-19, further comprising: transmitting capability information, wherein the capability information includes information identifying at least one of: an element grouping, an alphabet, a codebook, a switching speed, a dwell-time, a reflection coefficient, or a dither pattern; wherein receiving information identifying the RIS configuration comprises: receiving information identifying a selection of the codebook based at least in part on the capability information.
Aspect 21: The method of any of Aspects 12-20, further comprising: communicating with the network node to determine at least one of: a codeword, a periodicity, a group configuration, a per-group parameter, a time duration, or a time offset; and wherein receiving information identifying the RIS configuration comprises: receiving information identifying a selection of a codebook based at least in part on communicating with the network node.
Aspect 22: The method of any of Aspects 12-21, further comprising: transmitting, to the UE, information identifying one or more power control configuration parameters for communication via the RIS; and wherein forwarding the one or more communications comprises: forwarding the one or more communications in accordance with the one or more power control configuration parameters based at least in part on transmitting the information identifying the one or more power control configuration parameters.
Aspect 23: A method of wireless communication performed by a user equipment (UE), comprising: receiving, from a network node and via a reconfigurable intelligent surface (RIS), information identifying one or more power control configuration parameters for communication with the network node via the RIS, wherein the power control configuration parameters relate to a RIS configuration that includes one or more parameters for a time-varying control configuration associated with side-lobe suppression; and communicating, via the RIS and using the one or more power control configuration parameters, with the network node.
Aspect 24: The method of Aspect 23, wherein the one or more power control configuration parameters includes an indication in an entry of a power control look-up table, of a set of look-up tables, wherein the power control look-up table is configured for RIS-assisted uplink.
Aspect 25: The method of Aspect 24, further comprising: receiving, from the network node and via semi-static signaling, at least one of: information identifying the set of look-up tables, the indication of the entry of the power control look-up table, a selection of the power control look-up table from the set of look-up tables, a side-lobe suppression characteristic, a bandwidth threshold, or a configuration for interpreting transmit power control commands.
Aspect 26: The method of any of Aspects 23-25, wherein the one or more power control configuration parameters includes an indication of an adjustment step for adjusting a power control.
Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.
Aspect 28: An apparatus for wireless communication at a device, the apparatus comprising one or more memories and one or more processors coupled to the one or more memories, the one or more processors configured to cause the device to perform the method of one or more of Aspects 1-26.
Aspect 29: An apparatus for wireless communication, the apparatus comprising at least one means for performing the method of one or more of Aspects 1-26.
Aspect 30: A non-transitory computer-readable medium storing code for wireless communication, the code comprising instructions executable by one or more processors to perform the method of one or more of Aspects 1-26.
Aspect 31: A non-transitory computer-readable medium storing a set of instructions for wireless communication, the set of instructions comprising one or more instructions that, when executed by one or more processors of a device, cause the device to perform the method of one or more of Aspects 1-26.
Aspect 32: A device for wireless communication, the device comprising a processing system that includes one or more processors and one or more memories coupled with the one or more processors, the processing system configured to cause the device to perform the method of one or more of Aspects 1-26.
Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication, comprising:
one or more memories; and
one or more processors, coupled to the one or more memories, configured to cause the apparatus to:
transmit, to a reconfigurable intelligent surface (RIS), information identifying a RIS configuration, wherein the RIS configuration includes one or more parameters for a time-varying control configuration associated with side-lobe suppression; and
communicate, via the RIS and using the RIS configuration, with a user equipment (UE).

2. The apparatus of claim 1, wherein the one or more processors, to cause the apparatus to transmit the information identifying the RIS configuration, are configured to cause the apparatus to:
transmit information identifying a codebook of a set of codebooks, and wherein the codebook includes one or more codewords associated with the one or more parameters of the time-varying control configuration.

3. The apparatus of claim 1, wherein the RIS configuration is based at least in part on a parameter of the apparatus, the parameter of the apparatus including at least one of:
a device identity parameter,
a target incident signal direction parameter, or
a distance parameter.

4. The apparatus of claim 1, wherein the one or more processors, to cause the apparatus to transmit the information identifying the RIS configuration, are configured to cause the apparatus to:
transmit using a spatial quasi-colocation parameter, wherein the RIS configuration is based at least in part on the spatial quasi-colocation parameter.

5. The apparatus of claim 1, wherein the one or more parameters include at least one of:
a side-lobe-level (SLL) suppression parameter,
a frequency separation parameter,
an interference level parameter,
a directional parameter,
an angular parameter, or
a cardinality parameter.

6. The apparatus of claim 1, wherein the one or more processors are further configured to cause the apparatus to:
receive information identifying one or more codebooks supported by the RIS; and
transmit information identifying a selection of a codebook, of the one or more codebooks, based at least in part on the information identifying the one or more codebooks supported by the RIS.

7. The apparatus of claim 6, wherein the one or more processors are further configured to cause the apparatus to:
transmit first update information based at least in part on the information identifying the one or more codebooks supported by the RIS; and
receive second update information identifying another one or more codebooks supported by the RIS in connection with the first update information; and
wherein the one or more processors, to cause the apparatus to transmit the information identifying the selection, are configured to cause the apparatus to:
transmit information identifying the selection from the other one or more codebooks.

8. The apparatus of claim 1, wherein the one or more processors are further configured to cause the apparatus to:
receive information identifying one or more attributes of a codebook supported by the RIS,
wherein the one or more attributes includes at least one of:
a main-lobe directional attribute,
a beam width attribute,
a peak gain attribute,
a side-lobe gain attribute, or
a side-lobe directional attribute; and
wherein the one or more processors, to cause the apparatus to transmit information identifying the RIS configuration, are configured to cause the apparatus to:
transmit information identifying a selection of the codebook based at least in part on the one or more attributes.

9. The apparatus of claim 1, wherein the one or more processors are further configured to cause the apparatus to:
receive capability information from the RIS,
wherein the capability information includes information identifying at least one of:
an element grouping,
an alphabet,
a codebook,
a switching speed,
a dwell-time,
a reflection coefficient, or
a dither pattern;
wherein the one or more processors, to cause the apparatus to transmit information identifying the RIS configuration, are configured to cause the apparatus to:
transmit information identifying a selection of the codebook based at least in part on the capability information.

10. The apparatus of claim 1, wherein the one or more processors are further configured to cause the apparatus to:
communicate with the RIS to determine at least one of:
a codeword,
a periodicity,
a group configuration,
a per-group parameter,
a time duration, or
a time offset; and
wherein the one or more processors, to cause the apparatus to transmit information identifying the RIS configuration, are configured to cause the apparatus to:
transmit information identifying a selection of a codebook based at least in part on communicating with the RIS.

11. The apparatus of claim 1, wherein the one or more processors are further configured to cause the apparatus to:
transmit, to the UE, information identifying one or more power control configuration parameters for communication via the RIS; and
wherein the one or more processors, to cause the apparatus to communicate with the UE, are configured to cause the apparatus to:
communicate in accordance with the one or more power control configuration parameters.

12. An apparatus for wireless communication, comprising:
one or more memories; and
one or more processors, coupled to the one or more memories, configured to cause the apparatus to:
receive, from a network node, information identifying a reconfigurable intelligent surface (RIS) configuration, wherein the RIS configuration includes one or more parameters for a time-varying control configuration associated with side-lobe suppression; and
forward, using the RIS configuration, one or more communications between the network node and a user equipment (UE).

13. The apparatus of claim 12, wherein the one or more processors, to cause the apparatus to receive the information identifying the RIS configuration, are configured to cause the apparatus to:
receive information identifying a codebook of a set of codebooks, and wherein the codebook includes one or more codewords associated with the one or more parameters of the time-varying control configuration.

14. The apparatus of claim 12, wherein the RIS configuration is based at least in part on a parameter of the network node, the parameter of the network node including at least one of:
a device identity parameter,
a target incident signal direction parameter, or
a distance parameter.

15. The apparatus of claim 12, wherein the one or more processors, to cause the apparatus to receive the information identifying the RIS configuration, are configured to cause the apparatus to:
receive using a spatial quasi-colocation parameter, wherein the RIS configuration is based at least in part on the spatial quasi-colocation parameter.

16. The apparatus of claim 12, wherein the one or more parameters include at least one of:
a side-lobe-level (SLL) suppression parameter,
a frequency separation parameter,
an interference level parameter,
a directional parameter,
an angular parameter, or
a cardinality parameter.

17. The apparatus of claim 12, wherein the one or more processors are further configured to cause the apparatus to:
transmit information identifying one or more codebooks supported by the apparatus; and
receive information identifying a selection of a codebook, of the one or more codebooks, based at least in part on the information identifying the one or more codebooks supported by the apparatus.

18. The apparatus of claim 17, wherein the one or more processors are further configured to cause the apparatus to:
receive first update information based at least in part on the information identifying the one or more codebooks supported by the apparatus; and
transmit second update information identifying another one or more codebooks supported by the apparatus in connection with the first update information; and
wherein the one or more processors, to cause the apparatus to receive the information identifying the selection, are configured to cause the apparatus to:
receive information identifying the selection from the other one or more codebooks.

19. The apparatus of claim 12, wherein the one or more processors are further configured to cause the apparatus to:
transmit information identifying one or more attributes of a codebook supported by the apparatus,
wherein the one or more attributes includes at least one of:
a main-lobe directional attribute,
a beam width attribute,
a peak gain attribute,
a side-lobe gain attribute, or
a side-lobe directional attribute; and
wherein the one or more processors, to cause the apparatus to receive information identifying the RIS configuration, are configured to cause the apparatus to:
receive information identifying a selection of the codebook based at least in part on the one or more attributes.

20. The apparatus of claim 12, wherein the one or more processors are further configured to cause the apparatus to:
transmit capability information,
wherein the capability information includes information identifying at least one of:
an element grouping,
an alphabet,
a codebook,
a switching speed,
a dwell-time,
a reflection coefficient, or
a dither pattern;
wherein the one or more processors, to cause the apparatus to receive information identifying the RIS configuration, are configured to cause the apparatus to:
receive information identifying a selection of the codebook based at least in part on the capability information.

21. The apparatus of claim 12, wherein the one or more processors are further configured to cause the apparatus to:
communicate with the network node to determine at least one of:
a codeword,
a periodicity,
a group configuration,
a per-group parameter,
a time duration, or
a time offset; and
wherein the one or more processors, to cause the apparatus to receive information identifying the RIS configuration, are configured to cause the apparatus to:
receive information identifying a selection of a codebook based at least in part on communicating with the network node.

22. The apparatus of claim 12, wherein the one or more processors are further configured to cause the apparatus to:
forward, to the UE, information identifying one or more power control configuration parameters for communication via the apparatus; and
wherein the one or more processors, to cause the apparatus to forward the one or more communications, are configured to cause the apparatus to:
forward the one or more communications in accordance with the one or more power control configuration parameters based at least in part on transmitting the information identifying the one or more power control configuration parameters.

23. An apparatus for wireless communication, comprising:
one or more memories; and
one or more processors, coupled to the one or more memories, configured to cause the apparatus to:
receive, from a network node and via a reconfigurable intelligent surface (RIS), information identifying one or more power control configuration parameters for communication with the network node via the RIS, wherein the power control configuration parameters relate to a RIS configuration that includes one or more parameters for a time-varying control configuration associated with side-lobe suppression; and
communicate, via the RIS and using the one or more power control configuration parameters, with the network node.

24. The apparatus of claim 23, wherein the one or more power control configuration parameters includes an indication in an entry of a power control look-up table, of a set of look-up tables, wherein the power control look-up table is configured for RIS-assisted uplink.

25. The apparatus of claim 24, wherein the one or more processors are further configured to cause the apparatus to:
receive, from the network node and via semi-static signaling, at least one of:
information identifying the set of look-up tables,
the indication of the entry of the power control look-up table,
a selection of the power control look-up table from the set of look-up tables,
a side-lobe suppression characteristic,
a bandwidth threshold, or
a configuration for interpreting transmit power control commands.

26. The apparatus of claim 23, wherein the one or more power control configuration parameters includes an indication of an adjustment step for adjusting a power control.

27. A method of wireless communication performed by a network node, comprising:
transmitting, to a reconfigurable intelligent surface (RIS), information identifying a RIS configuration, wherein the RIS configuration includes one or more parameters for a time-varying control configuration associated with side-lobe suppression; and
communicating, via the RIS and using the RIS configuration, with a user equipment (apparatus).

28. The method of claim 27, wherein transmitting the information identifying the RIS configuration comprises:
transmitting information identifying a codebook of a set of codebooks, and wherein the codebook includes one or more codewords associated with the one or more parameters of the time-varying control configuration.

29. The method of claim 27, wherein the RIS configuration is based at least in part on a parameter of the network node, the parameter of the network node including at least one of:
a device identity parameter,
a target incident signal direction parameter, or
a distance parameter.

30. The method of claim 27, wherein transmitting the information identifying the RIS configuration comprises:
transmitting using a spatial quasi-colocation parameter, wherein the RIS configuration is based at least in part on the spatial quasi-colocation parameter.
